(19) United States
(12) Patent Application Publication
(10) Pub. No.: US 2005/0198071 A1
(43) Pub. Date: Sep. 8, 2005

(54) Recording medium having a data structure for managing various data streams and recording and reproducing methods and apparatuses

(76) Inventors: Jea Yong Yoo, Seoul (KR); Kang Soo Seo, Kyunggi-do (KR); Byung Jin Kim, Kyunggi-do (KR)

Correspondence Address: HARNESS, DICKEY & PIERCE, P.L.C., P.O. BOX 8910, RESTON, VA, 20195, US

(21) Appl. No.: 10/967,295

(22) Filed: Oct. 19, 2004

Related U.S. Application Data
(60) Provisional application No. 60/542,852, filed on Feb. 10, 2004.
(60) Provisional application No. 60/542,850, filed on Feb. 10, 2004.
(60) Provisional application No. 60/543,328, filed on Feb. 11, 2004.

(30) Foreign Application Priority Data
Mar. 4, 2004 (KR) 10-2004-0014709

(51) Int. Cl. G06F 7/00

(52) U.S. Cl. 707/104.1

(57) ABSTRACT

In the data structure for managing reproduction of various data streams, at least one navigation directory, a stream directory and an auxiliary directory is provided. The stream directory includes at least one stream file of main data and at least one stream file of supplemental data. The auxiliary directory has at least one auxiliary file of auxiliary data associated with the supplemental data, and the auxiliary file has a different file name extension than the stream file name extensions. The navigation directory includes navigation information for reproducing the main and supplemental data.

### CROSS-REFERENCE TO RELATED APPLICATIONS

This application claims the benefit of priority under 35 U.S.C. 119 on Korean Application No. 10-2004-0014709, filed on Mar. 4, 2004, which is hereby incorporated by reference in its entirety.

### BACKGROUND OF THE INVENTION

1. Field of the Invention

The present invention relates to high density recording media such as read-only blu-ray discs (BD-ROM).

2. Discussion of Related Art

Optical discs are widely used as an optical recording medium. Presently, of the optical discs, a new high density optical recording medium (HD-DVD), such as the Blu-ray Disc (hereafter called as “BD”), for recording and storing a large amount of high definition video and audio data is under development.

Currently, global standard technical specifications of the Blu-ray Disc (BD), a next generation HD-DVD technology, are being established as a next generation optical recording solution that can store amounts of data significantly surpassing present DVDs.

In relation to this, development of optical reproducing apparatuses for the Blu-ray Disc (BD) standards has also started. However, the Blu-ray Disc (BD) standards are not complete yet, and there has been difficulty in developing a completed optical reproducing apparatus.

Particularly, for effective reproduction of data from the Blu-ray Disc (BD), in addition to main AV data various kinds of other data (e.g., supplemental data such as subtitle data) may be reproduced for convenience of a user. Accordingly, management information should be provided for managing reproduction of the main data and the supplemental data. However, in the present Blu-ray Disc (BD) standards, because consolidated standards of the supplementary data, particularly the supplemental data are not complete yet, there are many restrictions on the development of a Blu-ray Disc (BD) optical reproducing apparatus, which causes problems with reproducing the subtitle information and providing it to the user according to a request of the user.

### SUMMARY OF THE INVENTION

A recording medium according to the present invention includes a data structure for managing reproduction of various data streams such as main, supplemental and auxiliary data streams.

In one embodiment, the recording medium stores at least one navigation directory, a stream directory and an auxiliary directory. The stream directory includes at least one stream file of main data and at least one stream file of supplemental data, and the auxiliary directory includes at least one auxiliary file of auxiliary data associated with the supplemental data. The navigation directory includes navigation information for reproducing the main and supplemental data.

In one embodiment, the auxiliary file has a different file name extension than the stream file name extensions. For example, the stream files may have a file name extension signifying that the stream files include data formatted according to the MPEG2 standard.

In one embodiment, the supplemental data may be interactive graphics data. Here, the auxiliary data may be sound data.

In another embodiment, the supplemental data may be text subtitle data. Here, the auxiliary data may be font data.

In one embodiment, the navigation directory is a playlist directory including at least one playlist file. The playlist file includes at least one playitem providing navigation information for reproducing the main data and at least one subpath providing navigation information for reproducing the supplemental data. For example, the subpath may include at least one sub-playitem, and the sub-playitem includes navigation information for reproducing the supplemental data.

The recording area may also include a clip information directory as a navigation directory. The clip information directory includes a clip information file associated with each stream file in the stream directory, and each clip information file provides information on the associated stream file.

In another embodiment of the present invention, the recording medium stores at least one navigation directory, a stream directory and an auxiliary directory. Here, the stream directory is for storing stream files including at least video data, the auxiliary directory is for storing at least one of sound and font files, and the navigation directory is for storing navigation information used to reproduced data in the stream files.

In one embodiment, the stream directory is for storing main data and supplemental data stream files, and the auxiliary directory is for storing at least one of sound and font data associated with the supplemental data in at least one of the supplemental data stream files.

In a further embodiment, the auxiliary directory is for storing auxiliary files having a different file name extension than the stream file name extensions.

The present invention further provides apparatuses and methods for recording and reproducing the data structure according to the present invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings;

FIG. 1 illustrates a file structure of a high density optical disc in accordance with one embodiment of the present invention;

FIG. 2 illustrates a file structure of a high density optical disc in accordance with another embodiment of the present invention;

FIG. 3 schematically illustrates a disc volume for storing the file structure of FIG. 1 or FIG.2 in accordance with an embodiment of the present invention;

FIGS. 4A and 4B illustrate diagrams each showing an exemplary case when supplemental data and a main A/V data are provided to a screen at the same time;

FIG. 5 illustrates a data structure and method of managing of the main and supplemental data streams in accordance with an embodiment of the present invention;

FIG. 6 illustrates a portion of the playlist PlayList data structure according to an embodiment of the present invention; and

FIG. 7 illustrates a detailed block diagram of an optical recording and reproducing apparatus according to an embodiment of the present invention.

### DETAILED DESCRIPTION OF THE INVENTION

Reference will now be made in detail to the embodiments of the present invention, examples of which are illustrated in the accompanying drawings. Wherever possible, the same reference numbers will be used throughout the drawings to refer to the same or like parts. While terms used in the present invention are possibly selected from currently well-known terms, terms are arbitrarily chosen by the applicant in some cases and their meanings are explained in detail in the following description. Hence, the present invention should be understood with the meanings of the corresponding terms chosen by the applicant instead of the simple names of the terms.

In relation to above, the main data in the present invention means, for example, title information on an optical disc such as video and audio data an author provides to a user, in general recorded in an MPEG2 format, and often referred to as a main AV stream.

The supplementary or supplemental data means data related to the main data and provided for a user convenience in reproduction. Supplemental data includes subtitle information, interactive graphics information (e.g., menu information), etc., recorded in the MPEG2 format multiplexed in a main AV stream, or in the MPEG2 format or other format and in a stream file independent from the main AV stream.

Therefore, the supplementary data in the present invention means data performing a supplemental role to help in the reproduction of main data such as caption information. Caption information is, for example, a form of subtitle information where the caption information is displayed on a screen when the user selects the subtitle for a particular language to watch along with a video (the main AV data).

A PopUp menu is introduced for providing detailed menu information according to the data attributes of a specific reproducing unit. The PopUp menu is graphics information provided through a small window, overlapping the currently reproduced picture in some cases. Such menu information is called as a PopUp.

The term Click sound means a brief sound provided for calling a user's attention to a selection made by a user such as a menu selection. A common name for a sound provided when a file is selected or activated is ‘Click sound,’ or ‘menu sound’.

The subtitle as a supplementary data means, for example, presentation graphics such as caption information or words of a song. Therefore, the subtitle may be written using various formats, such as MPEG2 transport (TS) packets, Bit-map form of binary format, text data, etc., and the subtitle recorded as text data is called a text subtitle.

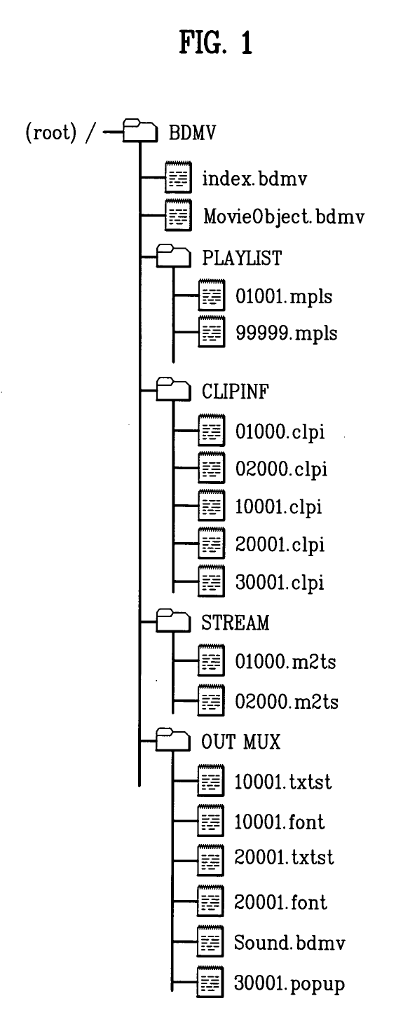

FIG. 1 illustrates a file structure of a high density optical disc in accordance with one embodiment of the present invention. As shown, the file structure includes at least one BD directory BDMV, under a root directory, having an index file index.bdmv and an object file MovieObject.bdmv as general files (upper files) for securing user interactivity. The index file index.bdmv is constructed centered on an index table having menu information and title information the user can select. The BD directory also includes a playlist directory PLAYLIST, a clipinfo directory CLIPINF, and a stream directory STREAM, and an outmux directory OUT MUX.

The stream directory STREAM has files on a main video and audio stream (called a main AV stream) recorded in MPEG 2 transport packets. Because the main AV stream is record in the MPEG2 format, the file name extension of the main AV stream files (e.g., 01000.m2ts and 02000.m2ts) will be “*.m2ts”.

Meanwhile, the streams of supplementary or supplemental data, provided for convenience of the user during reproduction of the main data are provided in a separate directory—the OUT MUX directory. The OUT MUX directory has supplemental and auxiliary data streams such as text subtitle (10001.txtst, 20001.txtst), Font (10001.font, 20001.font), (PopUp) menu (30001.popup), Click sound (Sound.bdmv), etc. The supplemental data such as interactive graphics (e.g., a PopUp menu) and a subtitle (e.g., a text subtitle) are related to the main AV stream, and are supported by the auxiliary data such a sound file and font file. For example, the sound file includes the click sound reproduced in association with a user's selection from the PopUp menu, and the font file includes a font used to reproduce the text subtitle. The supplemental and auxiliary data streams are not multiplexed with the main data stream.

When the supplementary and auxiliary data are managed in a separate directory wherein the supplemental and auxiliary data are not multiplexed with the main data stream, managing files and errors is easy.

For example, the supplementary and auxiliary data, generally being non real-time data, may be pre-loaded into a buffer such that managing files is easy.

The clipinfo directory CLIPINF has clipinfo files (e.g., 01000.clpi, 02000.clpi, and 10001.clpi, 20001.clpi, and 30001.clpi) having a one-to-one correspondence with stream files and some of the OUT MUX files *.m2ts, and *.txt. Particularly, the clipinfo file *.clpi has attribute information and timing information of a relevant file. The timing information includes information on mapping a presentation time stamp (PTS) of data in the file to a source packet number of a source packet in the file. Typically this map is referred to as an entry point map. In the BD standard, the AV stream *.m2ts, *.txt files, or etc. and the associated clipinfo file *.clpi are called a “clip”, collectively.

The playlist directory PLAYLIST includes a playlist file (*.mpls), and at least one playitem for designating a playing interval of a particular clip. Therefore, the playitem has information on a play starting time In-Time and play end time Out-Time of a particular clip desired to play, i.e., designated by a clip name Clip_Information_File in the playitem. The playlist file *.mpls is basic play file information for playing a desired clip by providing at least one playitem. Moreover, the playlist file *.mpls is provided with a sub-playitem as necessary. The sub-playitem provides the same information mentioned above for a playitem, except that the clips being managed by a sub-playitem are the files in the OUT MUX directory.

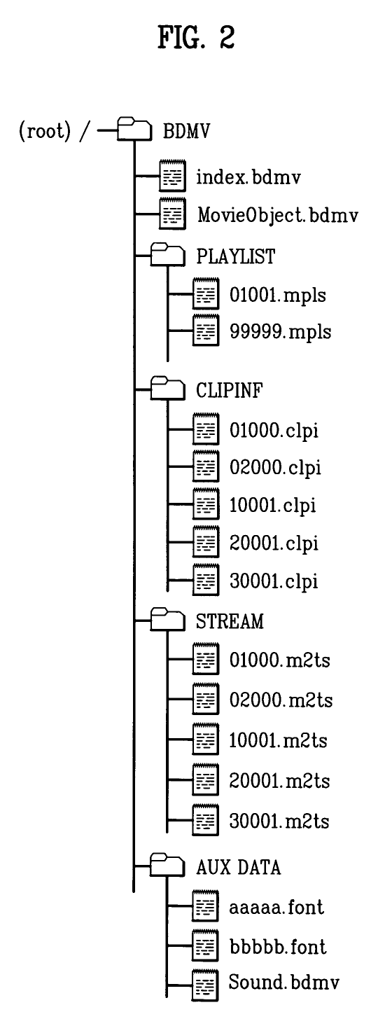

FIG. 2 illustrates a file structure of a high density optical disc in accordance with another embodiment of the present invention. In the file structure of FIG. 2, all supplementary data recorded in MPEG2 transport (TS) packet format among the supplementary data is included in the stream directory, and other data, called auxiliary data, such as aaaaa.font, bbbbb.font, Sound.bdmv are included in the auxiliary data directory AUX DATA. As a result, each file recorded in the streams directory has the same file extension “.m2ts.” For example, the text subtitle files 10001.m2ts, 20001.m2ts recorded in the STREAM directory and the PopUp menu file 30001.m2ts in the STREAM directory have an extension name of ‘m2ts.’

The files in the stream directory have a one-to-one correspondence with the clipinfo files 01000.clpi, 02000.clpi, 10001.clpi, 20001.clpi, and 30001.clpi in the clipinfo directory CLIPINF. In other words, the data are managed in a clip unit by the clipinfo files, which include the attribute information and the time information for the clip.

Meanwhile, the auxiliary data directory AUX DATA having a sound data file (Sound.bdmv) and font files (aaaaa.font, bbbbb.font) provides for separately managing this auxiliary data unmultiplexed with the main AV stream. Also, this auxiliary data does not have a corresponding clipinfo file and is not managed by the clipinfo files. Instead the supplemental data may directly identify the associated auxiliary data such that the appropriate auxiliary data is reproduced from an auxiliary data file, or the auxiliary data may be directly identified by the sub-playitem.

The sound data file (Sound.bdmv) stores sound data information (e.g., a click sound) related to an HDMV interactive graphic stream (e.g., a menu), and the font file (aaaaa.font, bbbbb.font) stores font information related to one or more text subtitles.

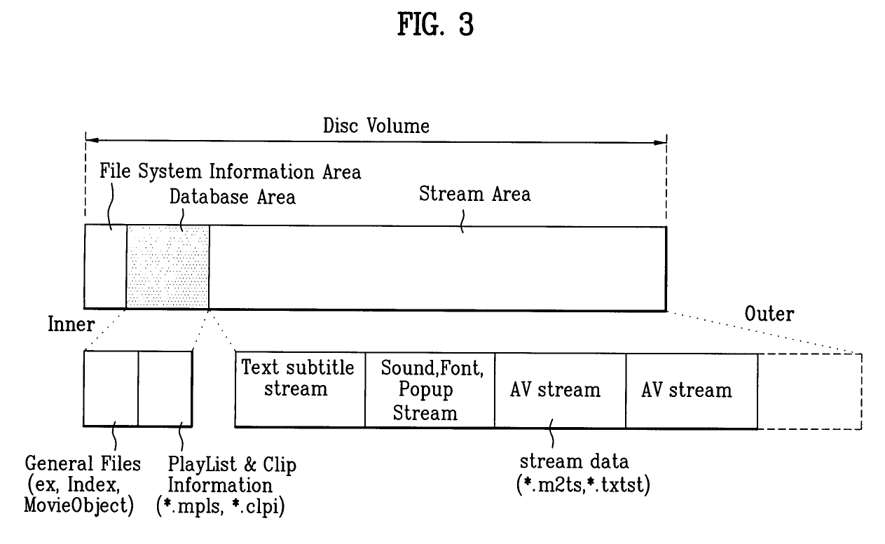

As shown in FIG. 3, the disc volume of a BD-ROM is organized into a file system information area, a database area, and a stream area. The file system information area stores system information for managing the disc. The database area includes a general files area and a playlist and clip information area. The general files area stores general files such as the index.bdmv file and the MovieObject.bdmv file. The playlist and clip information area stores the PLAYLIST directory and the CLIPINF directory. The main data, the supplementary data and the auxiliary data are recorded in the stream area. According to this, the reproducing apparatus determines the main data and the supplementary data desired to reproduce, by using file information in the data base area Database Area.

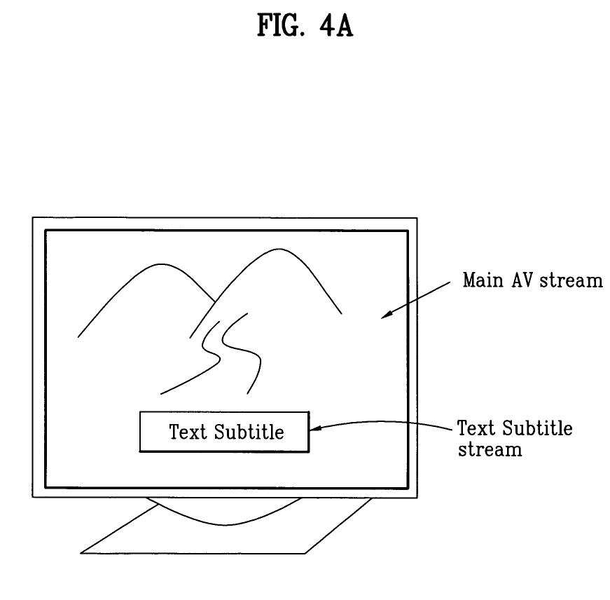

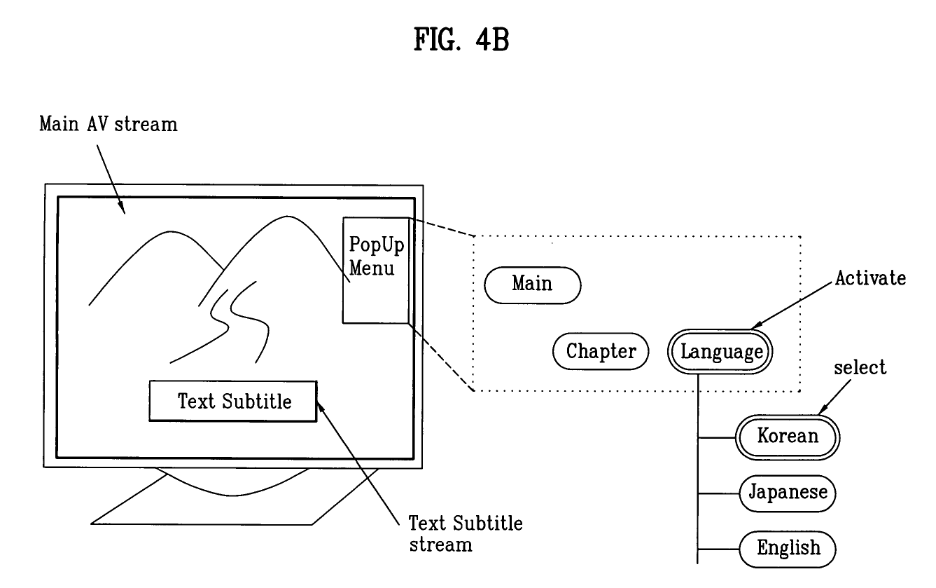

FIGS. 4A and 4B illustrate diagrams each showing an exemplary case when supplemental data and a main A/V data are provided to a screen at the same time. FIG. 4A illustrates a diagram of a case where the main A/V stream and a text subtitle are displayed on the screen at the same time, and FIG. 4B illustrates a diagram of a case where the main A/V stream, a text subtitle and a PopUp menu are displayed at the same time.

As illustrated in FIG. 4A, the text subtitle is displayed together with the main A/V stream. In other words, the text subtitle is caption information such as Korean and English for display according to the selection of the user. In this case, the text subtitle is reproduced through the sub-playitem separate from the playitem used in reproducing the main path, and the font for the text subtitle may be provided from the font file. Although activated separate from the playitem, the sub-playitem may be synchronized and displayed with the playitem by using information such as the PTS (Presentation Time Stamp) discussed above.

Furthermore, as illustrated in FIG. 4B, the main A/V stream may be displayed together with the text subtitle and a PopUp menu. The PopUp menu exists for providing different menu information according to the attributes of the data in the particular reproduction unit with which the PopUp menu is associated. As shown, the PopUp menu overlaps the main A/V stream by being reproduced in a small window on the screen.

The PopUp menu provides corresponding menu information when the user selects a button for performing the PopUp menu. For example, the user is able to select a ‘Language’ menu as low menu information by clicking the corresponding icon. Thereafter, when the user selects ‘Korean’ from the lower menu, the language used for reproducing the optical disc is set to ‘Korean’.

In this case, when the user selects a particular menu, the corresponding menu becomes active, and a simple sound is provided from the sound.bdmv file for calling the user's attention to the selection or to prevent a menu selection error. The sound provided when selecting or moving a menu button may be called a ‘Click sound.’

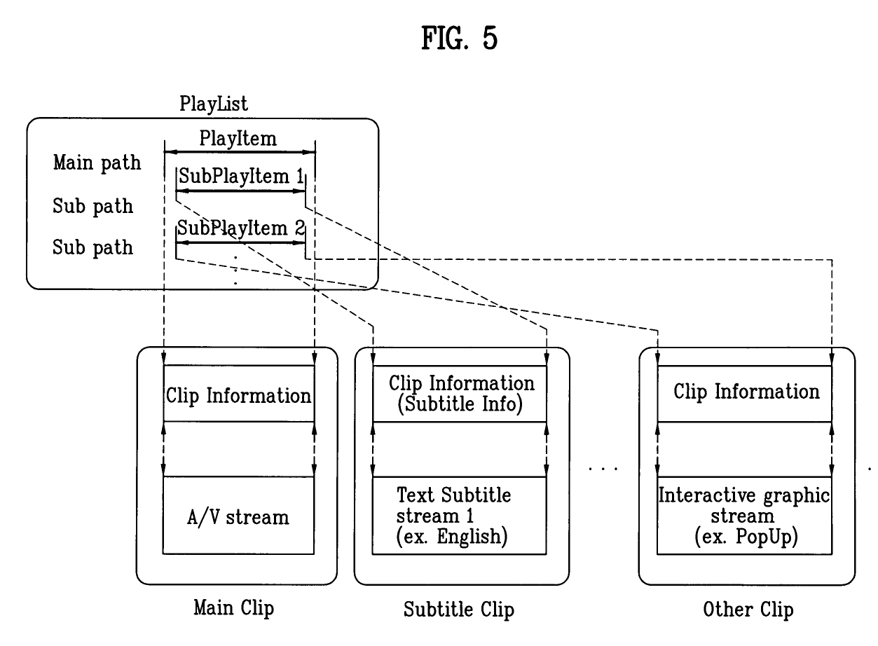

FIG. 5 illustrates a data structure and method of managing of the main and supplemental data streams in accordance with an embodiment of the present invention. As shown, the particular title desired to reproduce is managed by a playlist file. More specifically, a playitem PlayItem manages reproduction of the main A/V data, for example, a main path recorded on the main clip. Together with this, the supplemental data supplementing the main A/V data is recorded in one or more separate clips (e.g., a subtitle Clip), and managed by one or more sub-playitems SubPlayItem representing one or more sub-paths.

In general the supplemental data is divided into clips by data attribute and a sub-playitem manages one or more clips. In FIG. 5, the first sub-playitem SubPlayItem 1 may manage reproduction of a plurality of text subtitle clips supporting caption information such as Korean, or text, such as words of a song, and a plurality of clips except the text subtitle clips, for example, popup menu, supplementary audio, etc. is managed by the corresponding second sub-playitem SubPlayItem 2. Furthermore, the sub-playitems SubPlayItems 1 and 2 may include information for managing the reproduction of auxiliary data (e.g., sound and font data) in association with the supplemental data managed by the sub-playitem. For example, each sound data or font data in the sound file or font file may include an identifier, and a sub-playitem provides this identifier in association with the information for managing the supplemental data, which is associated with the auxiliary data identified by the identifier. Alternatively, the identifier may be provided in the supplemental data.

In this case, the playitem PlayItem in the playlist PlayList has reproduction management information for reproducing the main data, and the first and second sub-playitems SubPlayItems 1 and 2 have reproductions management information for reproducing the supplementary data.

Particularly, the playitem PlayItem has information on a play start time In-Time and play end time Out-Time of each clip. These time may be given as presentation time stamp (PTS) information. The main A/V stream file is further managed by the clipinfo file corresponding to the playitem PlayItem in the play list PlayList, and the clip information file name is provided in a Clip_Information_File_Name field in the play item PlayItem. The clipinfo file has the EP map mapping such that the PTS information from the playitem PlayItem may be converted into address information mapped to a particular location in the main A/V stream file. The address information is managed as a source packet number when the main A/V stream file is recorded in the MPEG2 TS format.

A sub-playitem SubPlayItem has information on a play start time In-Time and play end time Out-Time of the associated clips of supplemental data. These times may be given as presentation time stamp (PTS) information. The supplemental data stream files are further managed by the clipinfo file corresponding to the sub-playitem SubPlayItem in the playlist PlayList, and the clip information file name is provided in a Clip_Information_File_Name field in the sub-playitem SubPlayItem. The clipinfo file has the EP map such that the PTS information from the playitem PlayItem may be converted into address information mapped to a particular location in the supplemental data stream file. The address information is managed as a source packet number when the supplemental data stream file is recorded in MPEG2 TS format. It is also possible to use address information associated with a different recording format of the subtitle stream, for example, a source packet number (SPN), a sector number (SN), and a text line number (TLN).

Some of the characteristics of the embodiments in the present invention are summarized as follows.

First, the supplementary or auxiliary data streams may be managed in a separate directory or directories from the main AV stream data; and therefore, may be pre-loaded into memory of an optical reproducing apparatus before the main AV data is reproduced to facilitate reproduction of this information.

Second, all the supplementary data recorded in the MPEG2 transport packet format is included in the stream directory STREAM, and the auxiliary data are managed in the auxiliary directory AUX DATA. It should be noted that non-MPEG2 supplemental data may also be recorded in the auxiliary directory.

Third, the main data and the supplementary data are constructed in separate files, wherein the main data is managed by the playitem PlayItem, that is the main path of the playlist PlayList directory, and the supplementary data is managed by the sub-playitem SubPlayItem, that is the sub path of the playlist PlayList.

It should be understood that the characteristics of the embodiments of the invention listed above are not comprehensive, nor are they limiting.

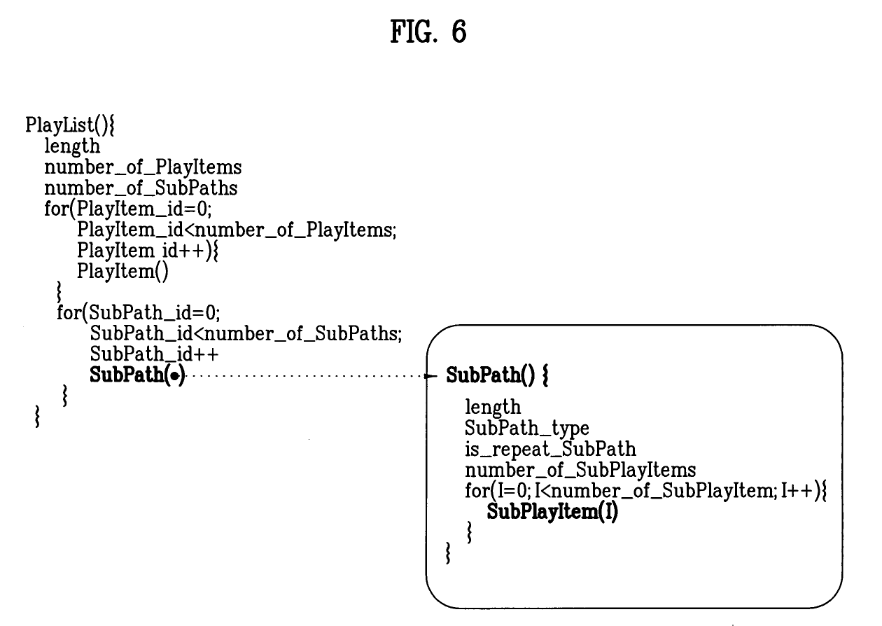

FIG. 6 illustrates a portion of the playlist PlayList data structure according to an embodiment of the present invention. As illustrated in FIG. 6, the syntax of the playlist PlayList includes a ‘number_of_PlayItems’ field representing the number of the playitems PlayItem in the playlist PlayList, a ‘number_of_subpath’ field representing the number of sub-paths SubPath in the playlist PlayList, a ‘PlayItem( )’field and a ‘SubPath( )’ field. As discussed above, the playitem PlayItem has a data structure syntax that includes, among other things, the start and end times for reproducing a clip associated with a clip information file named in a field of the playitem PlayItem.

The ‘SubPath( )’ field exists for providing supplementary presentation management information for managing supplemental data representing sub-paths related to the main path. Different types of sub-paths include an audio stream as background music, an interactive graphics presentation for interacting with the user, a text subtitle presentation, etc.

The ‘SubPath_type’ in the ‘SubPath( )’ syntax, as shown in FIG. 6, defines the sub-path type. Here, for example, the ‘SubPath_type’ means an audio presentation path of the browsable slideshow when the ‘SubPath_type’ is 2, an interactive graphics presentation menu when the ‘SubPath_type’ is 3, and a text subtitle presentation path when the ‘SubPath_type’ is 4.

An ‘is_repeat_SubPath’ field in the ‘SubPath’ syntax is a field for notifying whether the optical reproducing apparatus should repeat the presentation by using the sub-path information. The sub-path SubPath further includes a ‘number_of_SubPlayItems’ field for indicating the number of the sub-playitems, and includes a SubPlayItem field for each numbered sub-playitem. Particularly, the SubPlayItem (i) field in the SubPath( ) syntax, as aforementioned in FIG. 5, includes, among other things, the start and end times for reproducing a clip of supplemental data associated with a clip information file named in a field of the sub-playitem PlayItem.

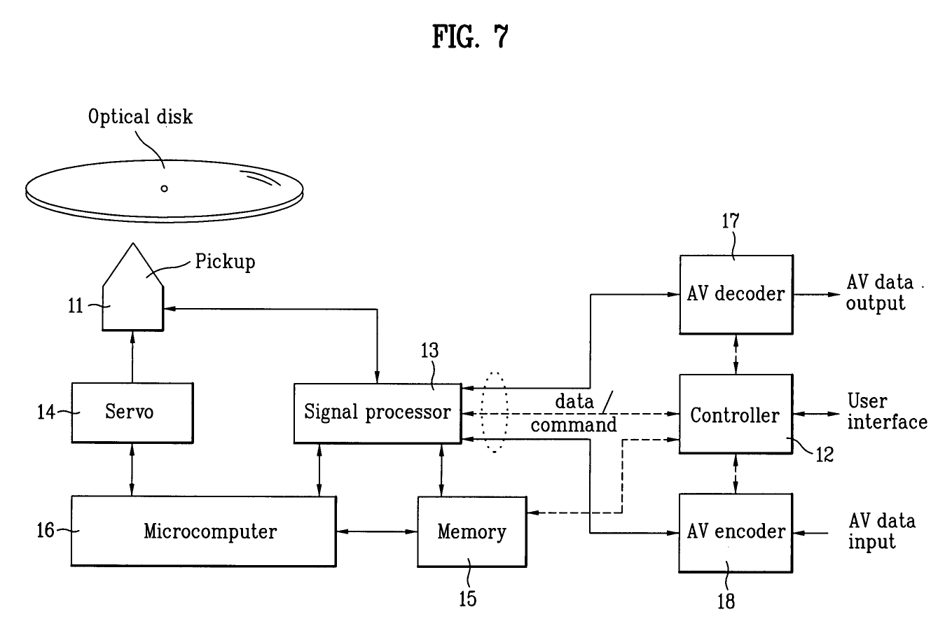

FIG. 7 illustrates a detailed block diagram of an optical recording and reproducing apparatus according to an embodiment of the present invention. As shown, the apparatus includes a pick up member 11 for retrieving the main data, the supplementary data, the auxiliary data and the reproduction managing information, a servo 14 for controlling movement of the pickup member 11, a signal processing portion 13 for restoring a reproduced signal received from the pickup portion 11 into a desired signal value or demodulating a signal to be recorded into a signal to be written on the optical disc, a memory 15 for preloading reproduction managing information and the supplemental and auxiliary data, and a microcomputer 16 for controlling the above described elements.

In relation to above, in the present invention, the memory 15 represents various storage devices (RAM, buffer, and the like) that can exist in the optical recording and reproduction apparatus, and it is apparent that the memory 15 may be replaced with a plurality of different storage devices.

An AV decoder 17 decodes data output from the signal processor 13, and provides the decoded data to the user under the control of a controller 12. An AV encoder 18 converts an input signal into a signal of a particular format, for an example, the MPEG2 TS transport stream, and provides the converted signal to the signal processing portion 13 under the control of the controller 12 to write data onto the optical disc.

The controller 12 controls the entire operation of the optical recording and reproduction apparatus in response to user input received over a user interface. For example the controller 12 controls the read out and storage of the management information (e.g., playitem and sub-playitem information), and uses this information in reproducing the main, supplemental and auxiliary data streams to meet a users desire as indicated in the user input.

While the invention has been disclosed with respect to a limited number of embodiments, those skilled in the art, having the benefit of this disclosure, will appreciate numerous modifications and variations there from. For example, while described with respect to a Blu-ray ROM optical disk in several instances, the present invention is not limited to this standard of optical disk or to optical disks. It is intended that all such modifications and variations fall within the spirit and scope of the invention.

1. A recording medium having a data structure for managing various data streams recorded on the recording medium, comprising:
a recording area recording at least one navigation directory, a stream directory and an auxiliary directory, the stream directory including at least one stream file of main data and at least one stream file of supplemental data, and the auxiliary directory having at least one auxiliary file of auxiliary data associated with the supplemental data, the auxiliary file having a different file name extension than the stream file name extensions, and the navigation directory including navigation information for reproducing the main and supplemental data.

2. The recording medium of claim 1, wherein the stream files have a same file name extension.

3. The recording medium of claim 2, wherein the stream files have a file name extension signifying that the stream files include data formatted according to the MPEG2 standard.

4. The recording medium of claim 1, wherein the main data is audio and video data.

5. The recording medium of claim 1, wherein the supplemental data is interactive graphics data.

6. The recording medium of claim 5, wherein the auxiliary data is sound data.

7. The recording medium of claim 1, wherein the supplemental data is text subtitle data.

8. The recording medium of claim 7, wherein the auxiliary data is font data.

9. The recording medium of claim 1, wherein the auxiliary data is one of sound and font data.

10. The recording medium of claim 1, wherein the navigation data indicates attributes of the main and supplemental data.

11. The recording medium of claim 1, wherein the navigation information does not provide information on the auxiliary files.

12. The recording medium of claim 1, wherein the navigation directory is a playlist directory including at least one playlist file, and the playlist file includes at least one playitem providing navigation information for reproducing the main data.

13. The recording medium of claim 12, wherein the playlist file further includes at least one subpath providing navigation information for reproducing the supplemental data.

14. The recording medium of claim 13, wherein the subpath includes a type indicator indicating a type of the subpath.

15. The recording medium of claim 13, wherein the subpath includes at least one sub-playitem, and the sub-playitem includes navigation information for reproducing the supplemental data.

16. The recording medium of claim 15, wherein the recording area includes a clip information directory as a navigation directory, and the clip information directory includes a clip information file associated with each stream file in the stream directory, each clip information file providing information on the associated stream file.

17. The recording medium of claim 16, wherein the playitem and sub-playitem, each identify an associated clip information file.

18. The recording medium of claim 16, wherein the clip information directory does not include a clip information file associated with an auxiliary file.

19. The recording medium of claim 1, wherein the recording area includes a clip information directory as the navigation directory, and the clip information directory includes a clip information file associated with each stream file in the stream directory, each clip information file providing information on the associated stream file.

20. The recording medium of claim 19, wherein the clip information directory does not include a clip information file associated with an auxiliary file.

21. A recording medium having a data structure for managing reproduction of various data streams, comprising:
a recording area storing at least one navigation directory, a stream directory and an auxiliary directory, the stream directory for storing stream files including at least video data, the auxiliary directory for storing at least one of sound and font files, and the navigation directory for storing navigation information used to reproduced data in the stream files.

22. The recording medium of claim 21, wherein
the stream directory is for storing main data and supplemental data stream files; and
the auxiliary directory is for storing at least one of sound and font data associated with the supplemental data in at least one of the supplemental data stream files.

23. The recording medium of claim 21, wherein the stream directory is for storing stream files having MPEG2 formatted data.

24. The recording medium of claim 21, wherein auxiliary directory is for storing auxiliary files having a different file name extension than the stream file name extensions.

25. A method of recording a data structure for managing reproduction of various data streams on a recording medium, comprising:
recording at least one navigation directory, a stream directory and an auxiliary directory on the recording medium, the stream directory including at least one stream file of main data and at least one stream file of supplemental data, and the auxiliary directory having at least one auxiliary file of auxiliary data associated with the supplemental data, the auxiliary file: having a different file name extension than the stream file name extensions, and the navigation directory including navigation information for reproducing the main and supplemental data.

26. An apparatus for recording a data structure for managing reproduction of various data streams on a recording medium, comprising:
a driver for driving an optical recording device to record data on the recording medium;
a controller for controlling the driver to record at least one navigation directory, a stream directory and an auxiliary directory on the recording medium, the stream directory including at least one stream file of main data and at least one stream file of supplemental data, and the auxiliary directory having at least one auxiliary file of auxiliary data associated with the supplemental data, the auxiliary file having a different file name extension than the stream file name extensions, and the navigation directory including navigation information for reproducing the main and supplemental data.

27. A method of reproducing a data structure for managing reproduction of various data streams from a recording medium, comprising:
loading at least one navigation directory, a portion of a stream directory and an auxiliary directory from the recording medium into a memory before reproduction of main data, the stream directory including at least one stream file of the main data and at least one stream file of supplemental data, the portion of the stream file being the supplemental data, and the auxiliary directory having at least one auxiliary file of auxiliary data associated with the supplemental data, and the navigation directory including navigation information for reproducing the main and supplemental data.

28. The method of claim 27, wherein the supplemental data is text subtitle data and the auxiliary data is font data.

29. An apparatus for reproducing a data structure for managing reproduction of data streams from a recording medium, comprising:
a driver for driving an optical reproducing device to reproduce data recorded on the recording medium;
a memory; and
a controller for controlling the driver to reproduce and load at least one navigation directory, a portion of a stream directory and an auxiliary directory from the recording medium into the memory before reproduction of main data, the stream directory including at least one stream file of the main data and at least one stream file of supplemental data, the portion of the stream file being the supplemental data, and the auxiliary directory having at least one auxiliary file of auxiliary data associated with the supplemental data, and the navigation directory including navigation information for reproducing the main and supplemental data.

30. The apparatus of claim 29, wherein the supplemental data is text subtitle data and the auxiliary data is font data.
